(19) United States
(12) Patent Application Publication
(10) Pub. No.: US 2019/0263643 A1
(43) Pub. Date: Aug. 29, 2019

(54) ENGINE CRADLE

(71) Applicant: Joshua T. Adamsky, Branchville, NJ (US)

(72) Inventor: Joshua T. Adamsky, Branchville, NJ (US)

(21) Appl. No.: 16/280,275

(22) Filed: Feb. 20, 2019

Related U.S. Application Data
(60) Provisional application No. 62/632,473, filed on Feb. 20, 2018.

(51) Int. Cl. B66F 7/28; B25H 1/00; B25B 11/00

(52) U.S. Cl. CPC B66F 7/28; B25B 11/00; B25H 1/0014

(57) ABSTRACT

An engine cradle system including a first support having a lifting mechanism coupled thereto and configured to slide along the first support, the lifting mechanism having a cradle assembly coupled thereto, where the cradle assembly includes a panel with a plurality of apertures with at least one of the plurality of apertures configured to secure an engine cradle to the panel.

### CLAIM OF PRIORITY

This application claims priority to U.S. Application Ser. No. 62/632,473 filed on Feb. 20, 2018, the contents of which are herein incorporated by reference in its entirety.

### FIELD OF THE EMBODIMENTS

The field of the embodiments relate to an apparatus for supporting, lifting, and moving an engine, specifically an engine of a motorcycle.

### BACKGROUND OF THE EMBODIMENTS

When working on engines and other heavy machinery back safety is always an issue. Having to move heavy machinery can lead to a number of injuries. Backs and discs can be pulled and strained. Dropped machinery can also injure feet and legs. Dropped machinery can also damage property, the machinery, and tools. Several stands and tools currently provide a way of securing motorcycles and other machinery in position that allow technicians to work on various components. Currently the typical practice is to use a motor bike stand to fix the motorbike in place and to lift the entire motorbike and along with a partner to remove the engine or manipulate it in order to work on the engine.

A review of related technology follows:

U.S. Pat. No. 4,077,607 pertains to a servicing rack for motorcycles and the like including a base having a track supported upward therefrom with a stationary section of the track and a pivotal section of the track adapted to receive the wheels of a vehicle such as a motorcycle or the like and support the vehicle in an elevated position for servicing, with power means for lifting the pivotal section of the track and the vehicle to the elevated position. The rack includes clamping means for clamping one wheel of the vehicle in position for holding it in an upright position and for cooperating with an adjustable support stand for supporting the vehicle in a suspended position when the pivotal portion of the track is lowered to the supporting surface.

U.S. Pub. 2004/0169167 pertains to a mobile engine lift apparatus having a base, an extendible vertical support, and pivotable cradle means for lifting, supporting and transporting a motorcycle engine. The apparatus may be rolled into position with the cradle means adjacent a motorcycle engine. Extension means may be engaged to raise the cradle means, thereby lifting the engine away from the motorcycle. The cradle means may be adjusted to a desired position to permit careful removal and replacement of a motorcycle engine without causing damage to the motorcycle or the engine. The apparatus permits lifting and movement of an engine by a single individual in a safe manner. The engine, supported by the cradle means, may then be moved to a preferred location for transfer to a servicing location. The engine may be serviced while supported in the apparatus, or it may be removed from the apparatus for servicing.

U.S. Pat. No. 6,371,449 pertains to a portable motorcycle hoist having a main frame assembly which includes a pair of vertically-oriented parallel channel beams rigidly affixed to both an upper cross brace and to a base member. The pair of channel beams provide a caged track for a trolley which is movably slidable therein between a lowermost position and an uppermost position. The trolley is fitted with a plurality of guide wheels to minimize sliding friction within the caged track. A cradle assembly, adapted to support a motorcycle beneath its engine, is attached to the trolley. The base member may also incorporate casters to facilitate the repositioning of a supported cycle.

European Application EP1724232 pertains to an apparatus for motorcycle lifting a motorcycle. The motorcycle is held by the apparatus at the handlebar and at another point, for example the central part of the frame, which rests on a removable support, for example a special jack, or on the stand of the motorcycle same.

However, none of the aforementioned art discloses a system of lifting the engine separately and giving the user the ability to manipulate the engine. A need clearly exists for a system that can be adapted to various motorcycle engines that allows a mechanic to easily support, lift, and move a motorcycle engine safely without injury and without assistance of another person.

### SUMMARY OF THE EMBODIMENTS

The present invention and its embodiments are generally related to helping a mechanic work on a motorcycle engine, by making it more manageable to lift and move and manipulate. Embodiments of the present invention include an engine cradle system including a first support having a lifting mechanism coupled thereto and configured to slide along the first support, the lifting mechanism having a cradle assembly coupled thereto, where the cradle assembly includes a panel with a plurality of apertures with at least one of the plurality of apertures configured to secure an engine attachment to the panel. The attachments are designed to accommodate all makes and models of motorcycles unlike other devices.

It is an object of the embodiments of the present invention to provide a lifting mechanism having a jack connected to a first end of a sleeve and a second end of the sleeve, the sleeve surrounding the first support. The sleeve can include a first section and a second section, the first section being affixed to the first support, and the second section being slidably coupled to the first support. The jack can be a bottle jack.

Yet another object of the embodiments of the present invention is the cradle assembly being rotatably coupled to the lifting mechanism, where the cradle assembly comprises an attachment section sized to mate with a receiving section of the lifting mechanism. The attachment section can include multiple angular positions relative to the receiving section in which the sections can be locked with respect to each other.

Yet another object of the embodiments of the present invention is the having the first support being coupled to an overhead support system. The first support can include a flange at an end and the overhead support system can include a matching flange, the flange and matching flange can be slidably coupled to each other. The flange and matching flange can be locked together in multiple relative positions by a pin and at least one set of matching apertures.

Yet another object of the embodiment of the present invention is having the panel be oriented in an oblique position with respect to the first support. The panel including the plurality of apertures can form a grid.

Yet another object of the embodiments of the present invention can include at least one support bar or at least a pair of bars, wherein each bar comprises at least one bend, or hook, or includes an anti-slip covering. The bar can also be telescopic and be extendable. The engine cradle can also include a ramp or lowering tray.

A further embodiment of the present invention includes a trolley system, the trolley system can be coupled to the inside of a trailer, attached to a structural component of a building, or based upon a floor post setup. All comprising a rail array, at least one set of rollers to slide along the rail array, the at least set of rollers having a housing attached thereto. A vertical bar can be coupled to the housing and have a lifting mechanism attached thereto. The lifting device configured for sliding along the vertical bar. The lifting mechanism can include a jack with a cradle assembly attached thereto, wherein the cradle assembly comprises a panel comprising a grid of apertures, the grid of apertures configured to receive a fastener there through to secure an engine attachment to the panel, wherein the engine attachment comprises at least one bar.

In addition to the foregoing, other objects, features, aspects and advantages of the embodiments of the present invention will be better comprehended through a careful reading of a detailed description provided herein below with appropriate reference to the accompanying drawings.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1A shows an isometric view of the system.

FIG. 1B shows a detailed view of the main unit in the system.

FIG. 2 shows an isometric view of the trolley system based off a ceiling setup.

FIG. 3 shows an isometric view of a trailer rail array set up.

FIG. 4A shows an isometric view of trolley detail.

FIG. 4B shows a detailed view of components of the trolley.

FIG. 5 shows a detail of the matching flanges.

FIG. 6A shows variations of engine cradle attachments.

FIG. 6B shows variations of engine cradle attachments in detail.

FIGS. 7A-C show details of a post floor mechanism.

### DETAILED DESCRIPTION OF THE PREFERRED EMBODIMENT

The preferred embodiments of the present invention will now be described with reference to the drawings. Identical elements in the various figures are identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations be made thereto. The description is not intended in a limiting sense and is made solely for the purpose of illustrating the general principles of the invention.

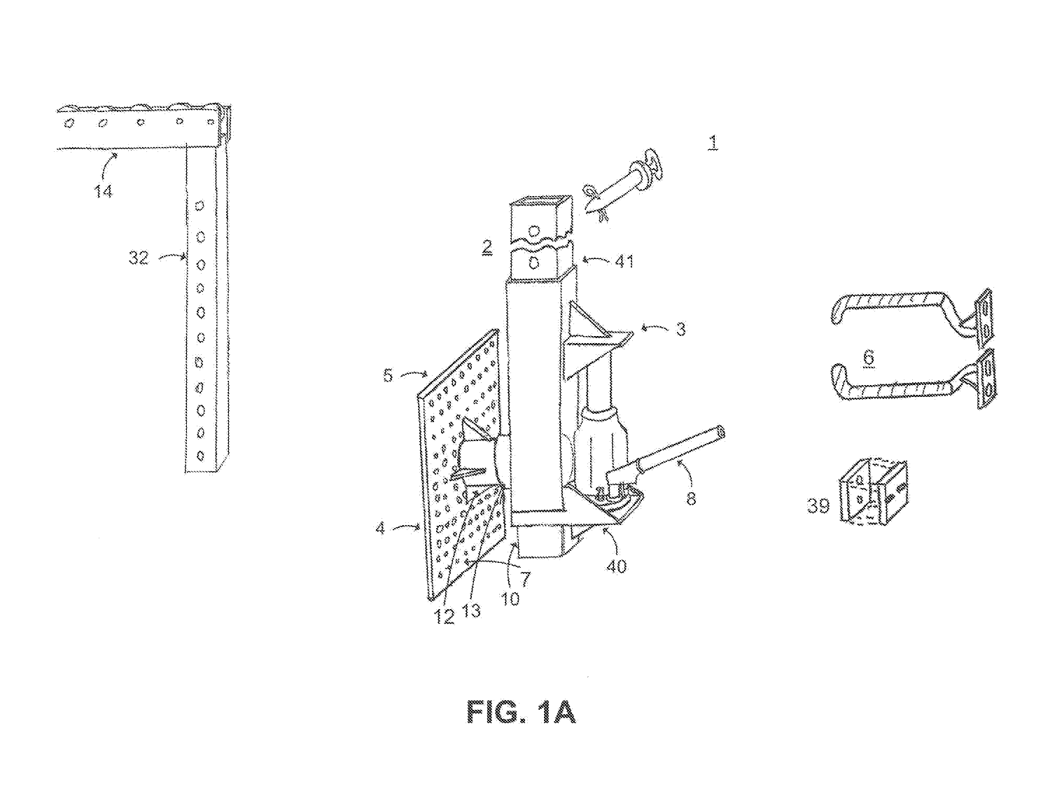

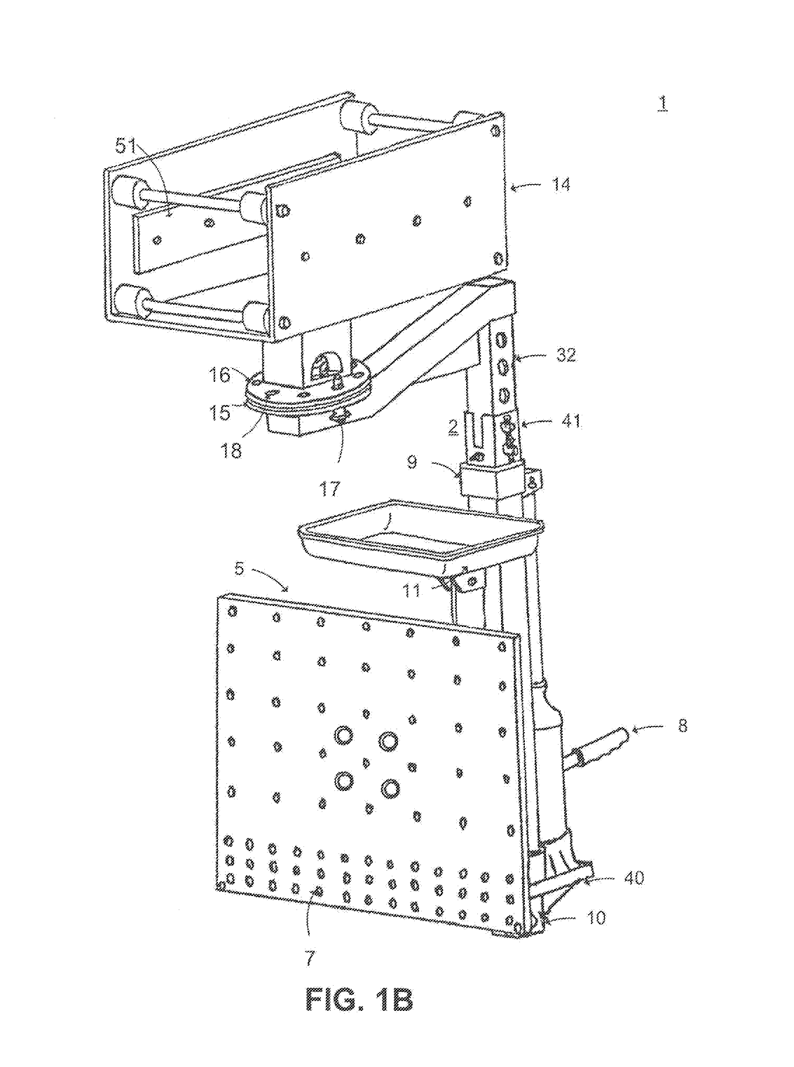

FIG. 1A shows an engine cradle system 1. The engine cradle system 1 can include a first support 2 having a lifting mechanism 3 coupled thereto. The lifting mechanism can be configured to slide along the first support 2. The lifting mechanism 3 can include a cradle assembly 4 coupled thereto, where the cradle assembly 4 can include a panel 5 with a plurality of attachments 6 with at least one of the plurality of attachments configured to secure an engine to the panel 5. A user is able to adjust a height of the cradle assembly 4 of engine cradle system 1, by adjusting the height of the first support 2 with respect to an attachment 32 by coupling through a set of apertures using a pin to set a preset height, and by adjusting the final height using the lifting mechanism 3. Once the proper height is selected, the engine attachment 6 can engage with an engine, preferably a motorcycle engine. The free engine, once separated from the rest of the motorcycle can then be moved about the room or trailer while hanging on the engine cradle 1 with relative ease. Details of the invention described in detail further, further explain how the engine is moved about.

Also seen in FIG. 1A, the lifting mechanism 41 includes a jack 8 connected by a pair of extending flanges or platforms to a first end 9 of a sleeve 41 and a second end 40 of the sleeve 2, the sleeve 41 surrounding the second support 2. The sleeve 2 can include a section 10. Section 10 being affixed to the first support 2. The second section 9, of 41 and 3, being slidably coupled to the second support 2. The jack 8 can be a bottle jack. The first section 10 can be welded to the second support 2. The first section 10, of 2 and 40, can include a platform on which the jack 8 can stand and be attached to. The jack 8 is for fine adjustment of the engine cradle 4, after the sleeve 41 is slid up and down the second support 2. As the jack 8 is ratcheted, the first section 10 stays stationary and the second section 9, along with the attached cradle assembly 4 is what moves up and along the second support 2. The second support 2 can be moved up and down with respect to the overhead support system 14, by positioning a pin through one of the numerous apertures located in the second support 2 and first support 32.

As can be seen further in FIG. 1A, the cradle assembly 4, can be rotatably coupled to the lifting mechanism 41. The rotation allows the engine attachments 6 and engine cradle assembly 4 to be positioned with respect to the engine in any angle between 20 degrees clockwise and counter-clockwise from a 12 o'clock position locked by a removeable pin through section (12 and/or 13). The rotation allows the engine once placed on the engine cradle assembly 4, to be rotated and manipulated to allow the mechanic the best access to the desired parts that need to cleaned, fluid drainage, parts repaired, or parts replaced. This function also allows engine removal and installation from the motorcycle to become easier if this function is needed. The cradle assembly 4 can include an attachment section 12 which is sized to mate with a receiving section 13 of the lifting mechanism 3. The attachment section 12 can fit inside of the receiving section 13 or vice versa. The mating section can include a series of springs that allow steady rotation and locking of the cradle assembly 4. The attachment section 12 can include multiple angular positions relative to the receiving section 13 in which the sections can be locked with respect to each other.

FIG. 1B shows a detailed view of the engine cradle system 1. The panel 5 preferably is a plate having a thickness of about a ½ inch made from aluminum or 5/16 inch thickness made from steel, a critical measurement to help ensure structural stability, but also ensure that the system is not too heavy to be operational. The attachments 6 are preferably about a ¾ of an inch in diameter, with ¼ inch slotted mounting plates and spaced between either 1 or 2 inches apart with 1 inch slots to provide full coverage over the aperture grid 7 in the motor plate 5. If extremely tight, fine tuning is needed to insert an attachments 6 into a motorcycle engine compartment, attachment add-on 39 may be used in conjunction with an attachment 6 to provide slotted adjustments in horizontal and vertical form. The aperture size is also important in order to help ensure that fasteners are able to provide the necessary support to the engine cradle 4 (as shown in FIG. 1A), when weighted with a motorcycle engine.

A second support 2 may also be coupled to an overhead support system 14. A vertical bar, first support 32, can be coupled to the second support 2 and 14 joining them. A pan 11 (such as an oil pan) may be attached to a section 9 connected to the sleeve 41 for holding parts, tools, bolts, attachments 6, and the like. The jack 8 is connected to the second end 40 and attached to the second support 2. The second section 10 is affixed to the second support 2.

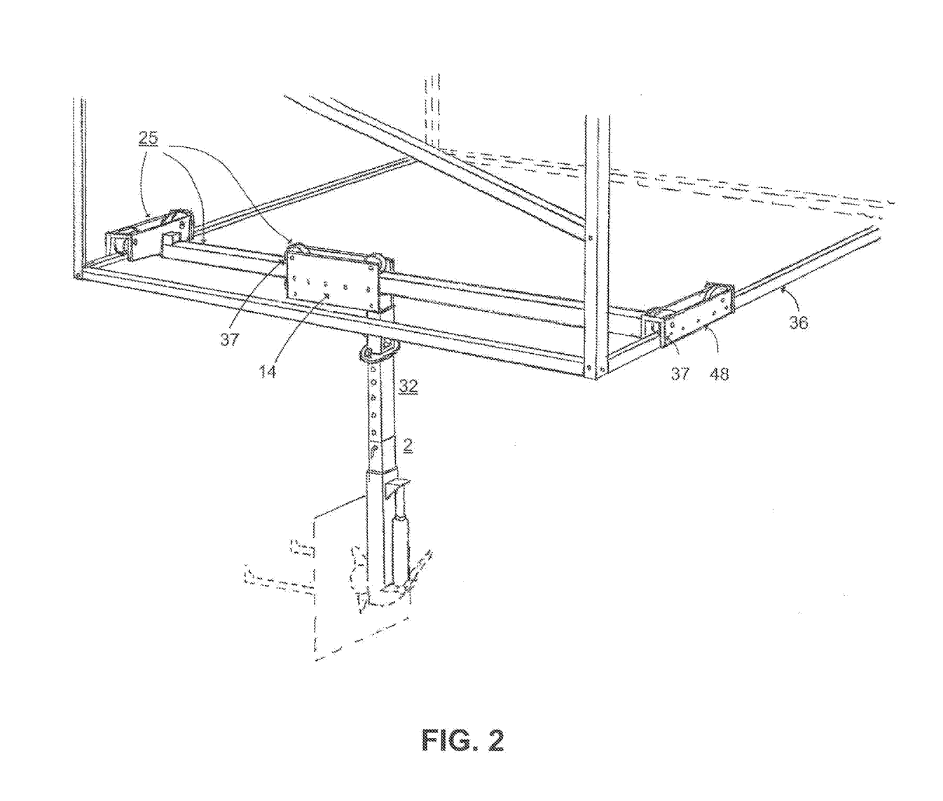

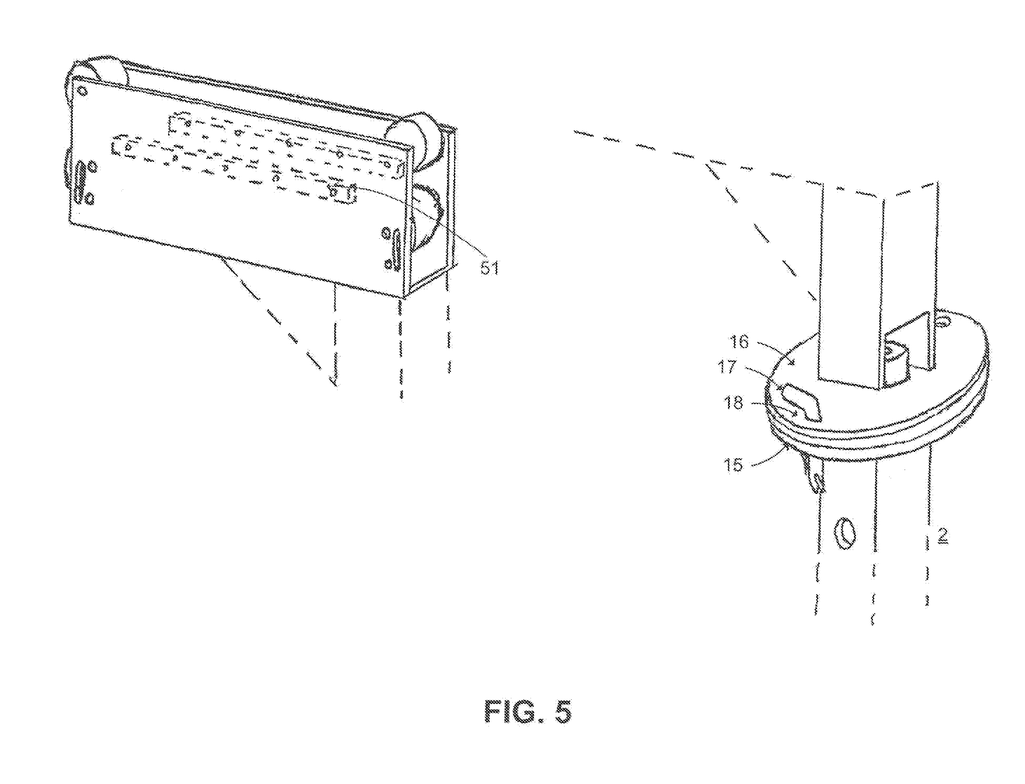

FIG. 2 shows the first support 32 being coupled to an overhead support system 14. The first support 32 can include a flange 15 (shown in FIG. 5) at an end and the overhead support 14 system can include a matching flange 16, the flange 15 and matching flange 16 can be slidably coupled to each other. The flange 15 and matching flange 16 can be locked together in multiple relative positions by a pin 17 and at least one set of matching apertures 18. This arrangement of flanges allows the engine cradle 1 to be rotated about 360 degrees, allowing the mechanic to again place the engine being worked on in the proper position. The flanges can be round, as seen in FIG. 2, and can include thrust bearings positioned at the center of the flanges allowing smooth movement of the first support 32 with respect to the overhead support system 14.

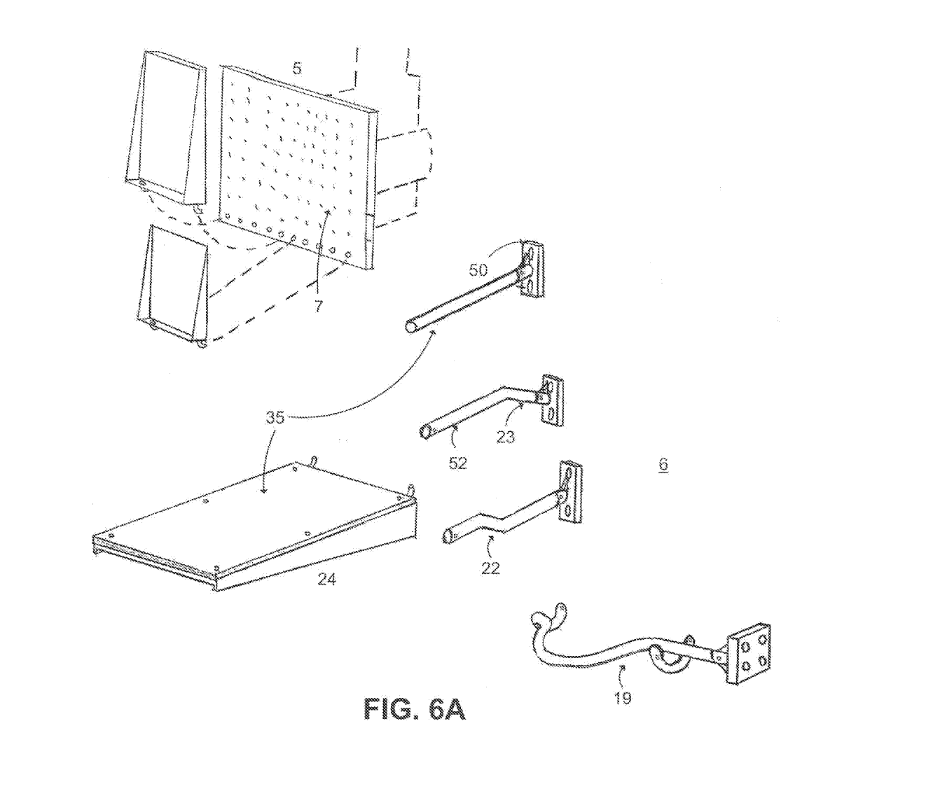

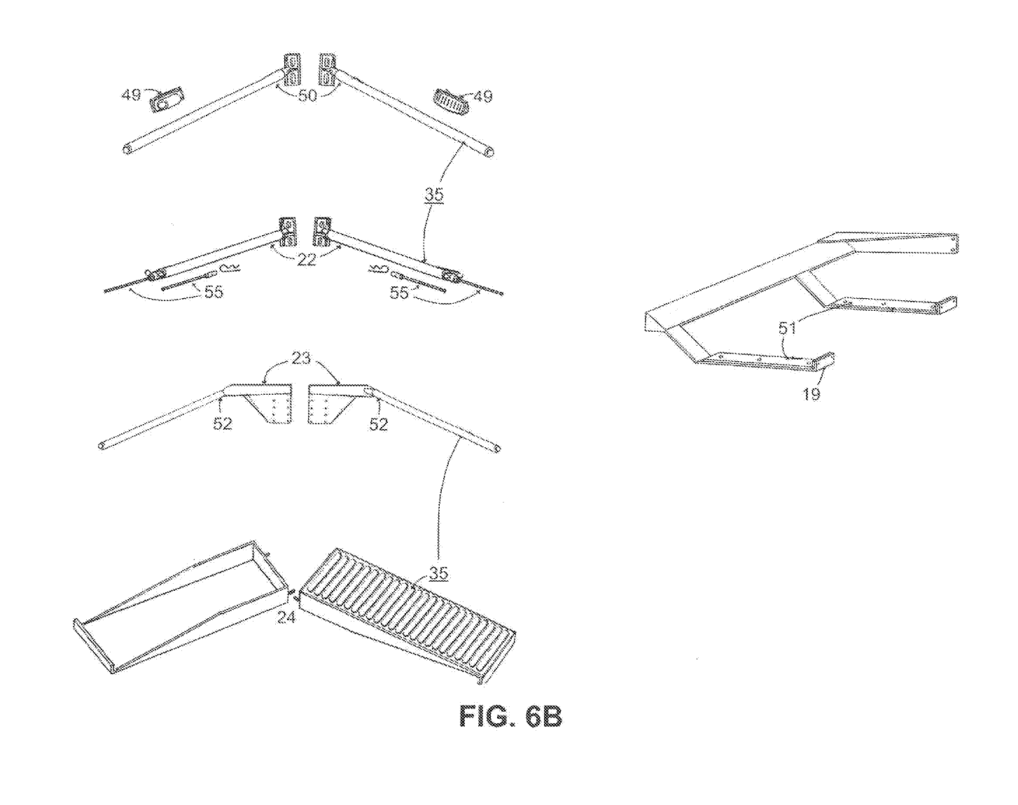

As seen in FIG. 6A: The panel/motor plate 5 can be oriented in an oblique position with respect to the second support 2. The panel 5 including the plurality of apertures 7 can form a grid. It is beneficial to orient panel 5 in an oblique manner, so that the weight and cantilever action of the engine positioned on the engine cradle assembly 4 pulls the panel into a vertical position and the engine is able to sit securely and be locked in a neutral position with locking pin through sections 12 and 13. The grid aperture pattern 7 on panel 5 allows the engine cradle attachments 6 or multiple engine cradle attachments 6 to be positioned at various widths apart. The grid 7 can include at least two sections, one where the attachments 6 are spaced closer together (mainly for lowering tray/ramp 24), and another where attachments are spaced further apart and the slotted apertures in the attachments 6 are used for fine adjustment. The difference in attachment width, along with a brace from section 12 to panel 5, helps the panel 5 keep structural integrity, while also being able to accommodate engine attachments 6, that have multiple attachment points, such as the ramp 24 which can include anti-slip cover 35.

As further seen in FIG. 6A: The engine attachments 6 can include at least one support bar component 50 or at least a pair of bars. Motor mount attachment 22 consists of various sized removeable engine motor mount attachments 48 locked in place with removeable pins for various sized motor mount locations. The engine attachments 6 can also be curved in a lateral direction 19. Attachment 19 is designed to be inserted through a motorcycle frame in a vertical position, lowered with the attachment legs facing downward around the frame, and then rotated and fastened in a horizontal position to cradle underneath in-line engines with driveshaft assemblies as well as other uses. Attachment 19 is lined with heavy duty plastic guide material 51 to prevent engine damage. The engine attachments 6 can also be accompanied by attachment add-ons such as attachment add-on 55 for attachment 22 and attachment add-on 49 for attachment component 50. Attachment add-on 49 is a slide-on attachment for cradling delicate, fragile, and air-finned engines to help prevent engine damage to the best of its capabilities. Attachment add-on 49 slides onto any straight attachment such as attachments 50, 22, and 52. Attachment 49 is covered/lined with anti-slip 35. Attachment 52 is an offset attachment for reaching to places beyond the capabilities of the panel/motor plate 5. Attachment 52 includes a mounting plate 23 that creates an extension for the support bar. The engine attachments 6 can also include a ramp 24.

The various types of supports allow the engine attachments 6 to be used with various types of engines. The preferred engine is a motorcycle engine. Various brands of motorcycles can be serviced when various engine attachments 6 are swapped in or out, engines can all be serviced based on the type of engine attachment 6 which is used. The engine attachments 6 being telescopic, not structurally, but as far as what point along the support bar an engine can be lifted allows for various size engines to be placed on the engine attachments 6. Although some preferred embodiments of the engine attachments 6 are shown, the engine attachments 6 could include variations with shallower and deeper bends and could also include multiple inflection points. Attachments 49, 50, 22, 52, and 24 are all coated in anti-slip 35.

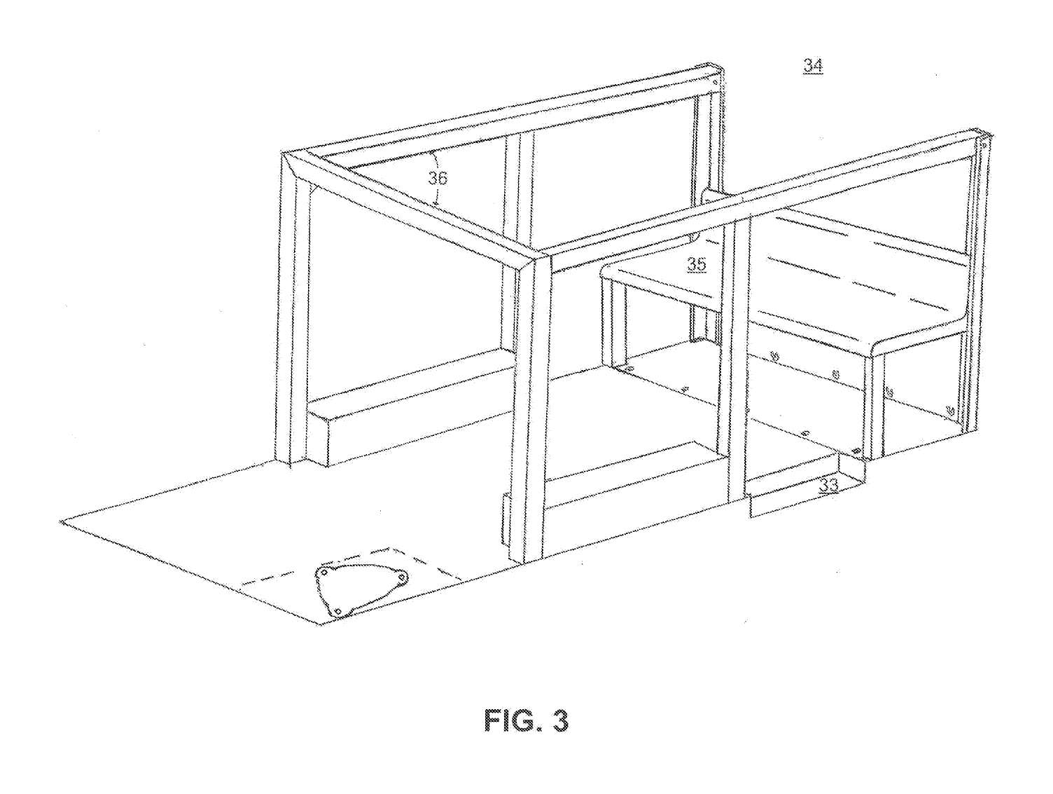

In an alternate embodiment the system 1 includes a trolley system 25. The trolley system 25 can be inside of a trailer, the trailer 34 shown in FIG. 3, with an entrance or step 33 and bench 35 being inside trailer 34.

As shown in FIG. 2: The system may also be attached to a structural component of a building. Comprising a rail array 36, with at least one set of rollers 37 to slide along the rail array 36, the at least set of rollers 37 having a housing 48 attached thereto. A vertical bar 32 can be coupled to the housing 14 and have a lifting mechanism 3 attached thereto. The lifting mechanism 3 configured for sliding along the vertical bar 2. Further shown in FIG. 1, the lifting mechanism 3 can include a jack 8 with a cradle assembly 4 attached thereto, wherein the cradle assembly 4 comprises a panel 5 comprising a grid of apertures 7, the grid of apertures configured to receive a fastener there through to secure an engine attachment 6 to the panel 5.

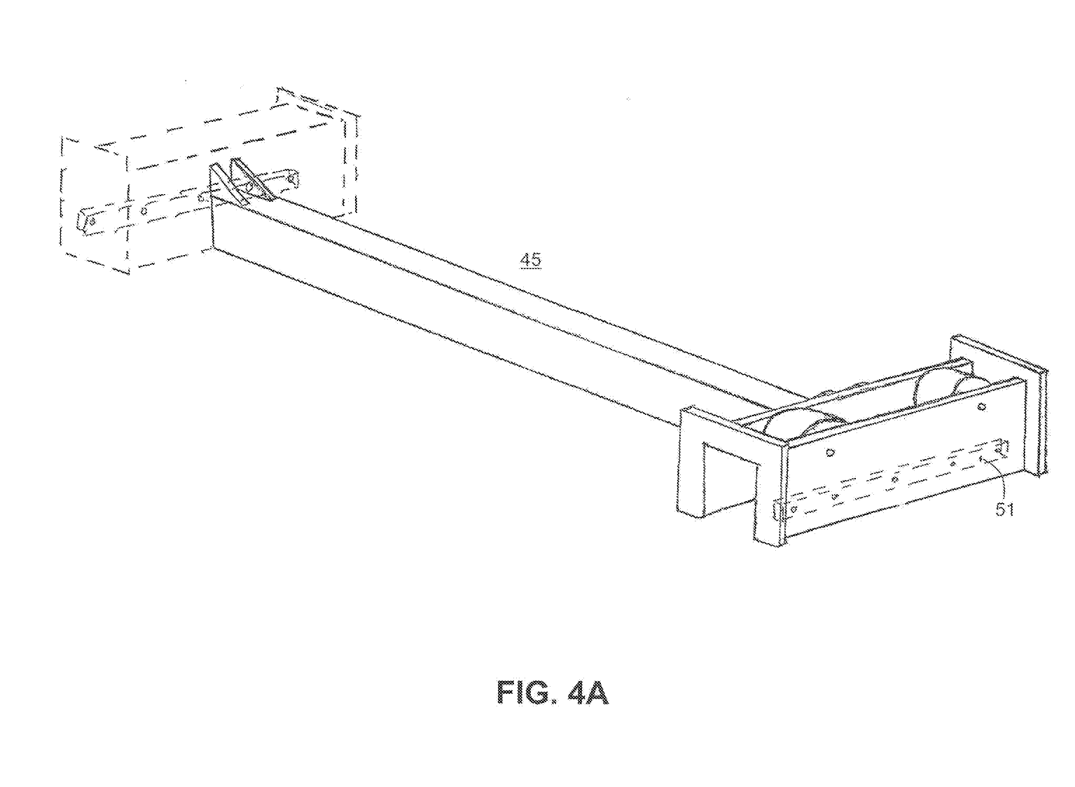

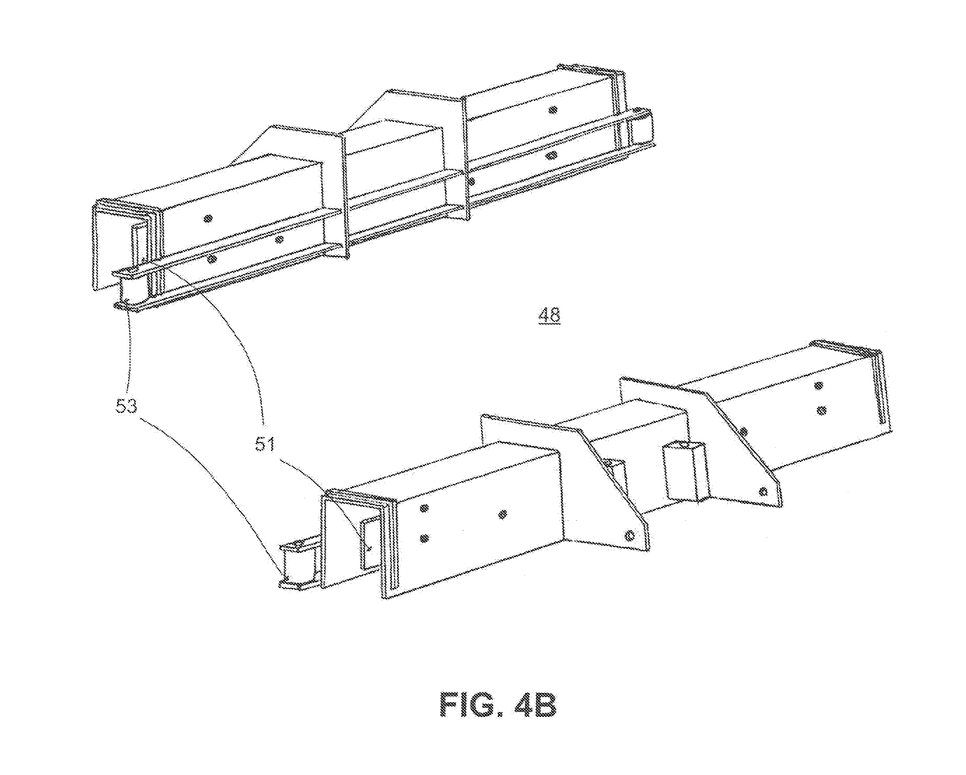

As shown in FIG. 4B: The trolley end housings 48 work in conjunction with a series of cross bars, tracks or rails, configured for allowing, a series of rollers to slide on. The rollers 37, detailed in FIGS. 4A and 4B, can be sandwiched in a housing 48 comprising at least a pair of panels. The panels are lined with heavy duty plastic guides 51 to help ease with the sliding movement of the trolley system. In addition, 48 is fitted with vertically mounted wheels 53 to ease the sliding movement and centering of the trolley system in conjunction with the guide 51. The arrangement of rails 47 or 36 in FIGS. 2, 3, 7A, and 7C and rollers allows the system 1, to slide in two dimensions across a plane, further allowing the perfect positioning and movement of an engine. The housings can include plastic/polyethylene strips such as the guide 51 to help position the rails and rollers in place. The plastic/polyethylene strips can provide lateral support, or provide an opposing force to the weight and pull of the vertical bar 2 when maneuvering the system 1.

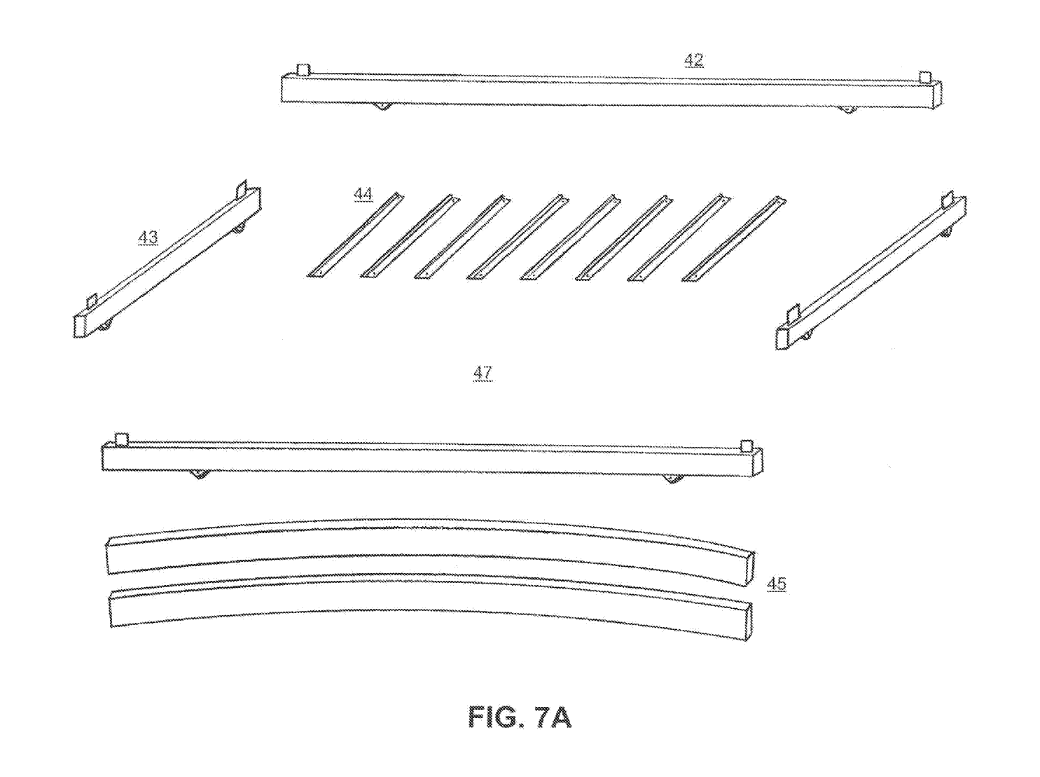

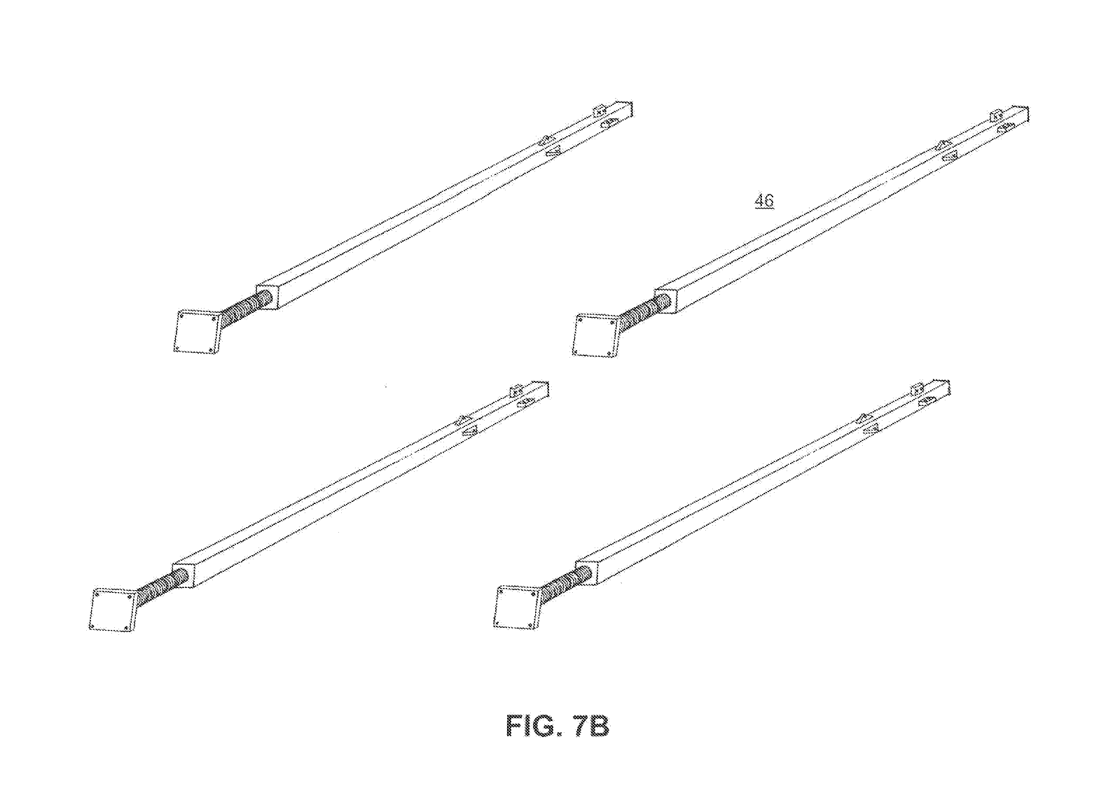

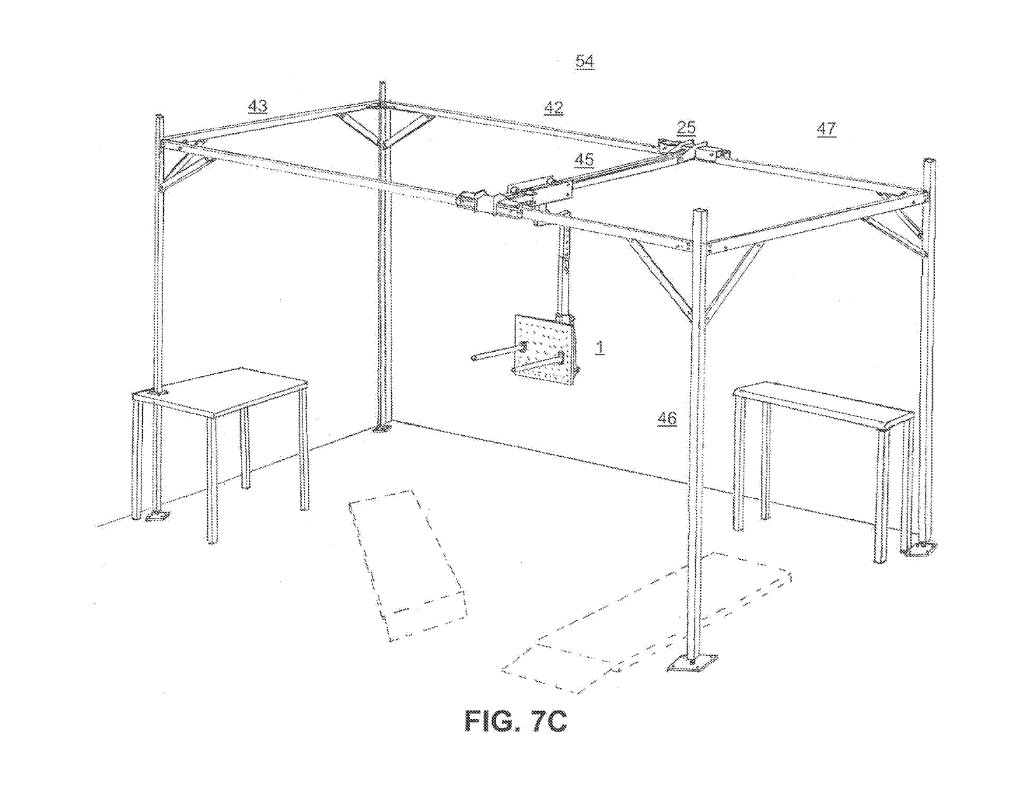

FIGS. 7A-C show details of a Multiple Post Floor Fixed Mechanism 47 (shown in FIG. 7C) for the engine cradle system 1. The multiple post floor mechanism 54 can include rails 42 and 43 with braces 44 (shown in FIGS. 7A and 7C). Alternatively, the post floor mechanism 54 can include curved rails 45 between the trolley ends 48 on the moveable trolley for weight enhancing ability. Curving the unbraced rail 45 vertically strengthens the structure of the material to hold more weight with less flex from gravitational force. The post floor mechanism 54 can also include posts 46. A height of the posts 46 can be adjustable. The posts 46 can be situated on a floor or through other support structures such as a table or workbench. The posts 46 may be adjusted for various ceiling heights. The posts 46 may be altered if needed to accommodate special needs in the surrounding environment with the aid of an experienced worker/fabricator/welder to assure structural integrity.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An engine cradle system comprising:
a first support configured to a second support adjusted upon themselves with a fixed adjustment, the second support having a lifting mechanism coupled thereto and configured to slide along the second support, the lifting mechanism having a rotational cradle assembly coupled thereto, wherein the cradle assembly comprises a panel comprising a plurality of apertures therethrough with at least one of the plurality of apertures configured to secure an engine cradle to the panel.

2. The engine cradle system of claim 1, wherein the lifting mechanism has a jack connected to a first end of an outer sleeve and a second end of a separate sleeve also called the second support, the sleeve surrounding the first support.

3. The engine cradle system of claim 2, wherein the sleeve comprises a first section and a second section, the second section being affixed to the second support, and the first section being slidably coupled to the second support via the outer sleeve.

4. The engine cradle system of claim 1, wherein the cradle assembly is rotatably coupled to the lifting mechanism.

5. The engine cradle system of claim 4, wherein
the cradle assembly comprises an attachment section sized to mate with a receiving section of the lifting mechanism, and wherein
he attachment section includes multiple angular positions and a centered locked position relative to the receiving section.

6. The engine cradle system of claim 1, wherein the first support is coupled to an overhead support system.

7. The engine cradle system of claim 6, wherein
the first support comprises a flange at an end and the overhead support system comprises a matching flange, the flange and matching flange being rotatably coupled to each other, and wherein
the flange and the matching flange are lockable in multiple relative positions by a pin and matching apertures.

8. The engine cradle system of claim 1, wherein the panel is oriented in an oblique position with respect to the first support.

9. The engine cradle system of claim 8, wherein the plurality of apertures form a grid.

10. The engine cradle system of claim 9, wherein the plurality of apertures are fastened to engine attachments.

11. The engine cradle system of claim 10, wherein the engine attachments comprise at least one support bar.

12. The engine cradle of claim 11, wherein the engine attachments comprise at least a pair of support bars.

13. The engine cradle system of claim 12, wherein each of the at least one support bar has at least one add-on attachment.

14. The engine cradle system of claim 12, wherein the at least one support bar has an anti-slip covering.

15. The engine cradle system of claim 10, wherein
the engine attachments comprise at least one ramp, and wherein
the at least one ramp has an anti-slip covering.

16. The engine cradle system of claim 1, wherein the lifting mechanism comprises a bottle jack.

17. An engine cradle system comprising:
a trolley system comprising a rail array, at least one set of rollers configured to slide along the rail array, the at least one set of rollers having a housing attached thereto;
a vertical bar being coupled to the housing;
the vertical bar having a lifting mechanism attached thereto and configured for sliding along the vertical bar; and the lifting mechanism comprising a jack with a cradle assembly attached thereto, wherein the cradle assembly comprises a panel comprising a grid of apertures, the grid of apertures configured to receive a fastener there through to secure an engine attachment to the panel; and wherein the engine attachment comprises at least one support bar or wherein the attachment comprises a ramp or wherein the attachment comprises an add-on attachment.

18. The engine cradle system of claim 17, wherein the rail array is attached to an inside of a trailer or mobile unit.

19. The engine cradle system of claim 17, wherein the rail array is attached to a building or structural part of a building.

20. The engine cradle system of claim 17, wherein the rail array is attached to a contained multiple post floor setup.
